(19) United States
(12) Patent Application Publication
(10) Pub. No.: US 2023/0297695 A1
(43) Pub. Date: Sep. 21, 2023

(54) SECURE GENERATION OF PAIRING KEYS

(71) Applicants: STMicroelectronics (Grand Ouest) SAS, Le Mans (FR); STMicroelectronics SA, Montrouge (FR)

(72) Inventors: Thierry Biniguer, Le Mans (FR); Benjamin Baratte, Montrouge (FR)

(21) Appl. No.: 18/179,893

(22) Filed: Mar. 7, 2023

(30) Foreign Application Priority Data
Mar. 18, 2022 (FR) 2202421

(51) Int. Cl. G06F 21/60; G06F 21/79

(52) U.S. Cl. CPC G06F 21/602; G06F 21/79

(57) ABSTRACT

In an embodiment a method includes receiving, by a first circuit of a device, a first identifier from a second circuit, generating, by the first circuit, at least one key based on the first identifier, a second identifier of the first circuit and a first key, storing, by the first circuit, the at least one key in a memory of the device, transmitting, by the first circuit, the at least one key to the second circuit and removing, by the first circuit, the at least one key from the memory, wherein the at least one key is generated by the first circuit in response to a request for communication with the second circuit, and wherein the first circuit executes one or more cryptographic operations based on the at least one key.

### CROSS-REFERENCE TO RELATED APPLICATIONS

This application claims the benefit of French Application No. 2202421, filed on Mar. 18, 2022, which application is hereby incorporated herein by reference.

### TECHNICAL FIELD

The present disclosure generally concerns the generation and the management of pairing keys between two electronic components.

### BACKGROUND

The pairing between two electronic elements of an electronic device is performed by means of pairing keys. Pairing keys are generally generated during the device manufacturing and then injected and stored in secure fashion in the device.

However, there is a technical problem to keep pairing keys secret during the lifetime of the device.

### SUMMARY

Embodiments provide improvements to the security of the management of such pairing keys.

An embodiment provides a method comprising:
the reception, by a first circuit of a device and from a second circuit, of a first identifier of the second circuit;
the generation, and the storage in a memory of the device, of at least one key by the first circuit, based on: the first identifier; a second identifier of the first circuit; and a first key;
the transmission by the first circuit of said at least one key to the second circuit;
the suppression from the memory of said at least one key in the first circuit;
a new generation of said at least one key by the first circuit as a response to a request for communication with the second circuit; and
the execution, by the first circuit, of one or a plurality of cryptographic operations, based on said at least one key.

According to an embodiment, the generation of said at least one key comprises:
the generation, by the first circuit, of a second key, based on the first key and on the first identifier; and
the generation, by the first circuit, of said at least one key, based on the second key and on a first data value.

According to an embodiment, the generation of the second key is performed by a first cryptographic processor of the first circuit and the generation of said at least one key is performed by a second cryptographic processor of the first circuit.

According to an embodiment, the value of the second key is transmitted by the first cryptographic processor to the second cryptographic processor via a dedicated bus coupling together the first and second cryptographic processors.

According to an embodiment, the second key is a key depending on the hardware of the first circuit.

According to an embodiment, the second key is a key deprived of a third key, the third key being a key depending on the hardware of the first circuit.

According to an embodiment, the above method further comprises the generation of the first data value, by the first circuit, based on the first identifier and on the second identifier and on an index value.

According to an embodiment, the generation of the first data value is performed by application of a hash algorithm on the first identifier and on the second identifier and on the index value.

According to an embodiment, said at least one key comprises a symmetric key.

An embodiment provides an electronic device comprising a first circuit configured to:
receive, from a second circuit, a first identifier of the second circuit;
generate and store, in a memory of the device, at least one key, the generation being performed based on: the first identifier; a second identifier of the first circuit; and a first key;
transmit said at least one key to the second circuit;
suppress from the memory said at least one key;
generate again said at least one key by means of the first circuit as a response to a request for communication with the second circuit; and
execute one or a plurality of cryptographic operations, based on said at least one key.

According to an embodiment, the above device comprises:
a first cryptographic processor configured to generate a second key, based on the first key and on the first identifier; and
a second cryptographic processor configured to generate said at least one key, based on the second key and on a first data value, the first and the second cryptographic processors being coupled by a dedicated bus.

An embodiment provides a system comprising:
the above electronic device; and
the second circuit, the first and second circuits being configured for the implementation of the above method.

According to an embodiment, the second circuit comprises a one-time programmable memory configured to store the at least one key generated by the first circuit.

### BRIEF DESCRIPTION OF THE DRAWINGS

The foregoing features and advantages, as well as others, will be described in detail in the rest of the disclosure of specific embodiments given by way of illustration and not limitation with reference to the accompanying drawings, in which:

FIG. 1 schematically shows in the form of blocks an electronic device according to an embodiment of the present disclosure;

FIG. 2 schematically shows in the form of blocks a processing unit configured for the generation of pairing keys, according to an embodiment of the present disclosure;

FIG. 3 illustrates a method of generation of pairing keys according to an embodiment of the present disclosure; and

FIG. 4 is a flowchart of a method of generation of pairing keys according to an embodiment of the present disclosure.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the design of the processing devices is well known by those skilled in the art and certain elements have not been detailed in the following description.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless otherwise specified, when reference is made to absolute positional qualifiers, such as the terms “front”, “back”, “top”, “bottom”, “left”, “right”, etc., or to relative positional qualifiers, such as the terms “above”, “below”, “upper”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

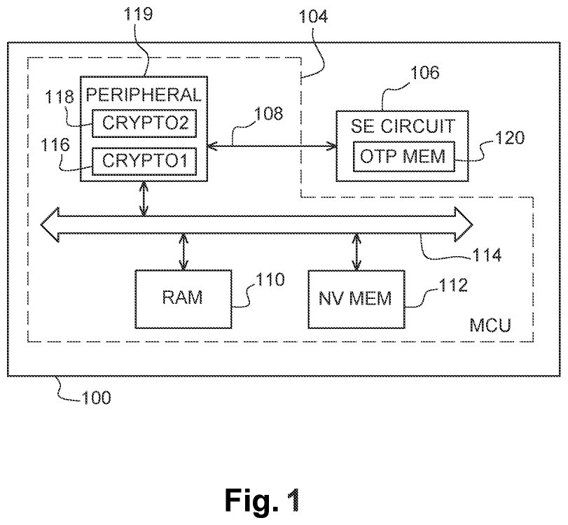

FIG. 1 schematically shows in the form of blocks an electronic device wo comprising a processing unit 104 (MCU) (“Microcontroller Unit”) according to an embodiment of the present disclosure.

Electronic device 100 is for example an electronic board such as a microcircuit card, computer equipment, a microprocessor circuit, etc.

Device wo further comprises a secure circuit 106 (SE CIRCUIT) coupled to processing unit 104 via a bus 108. Bus 108 is for example a dedicated bus exclusively coupling processing unit 104 and secure circuit 106. Bus 108 is for example a bus of I2C (“Inter-Integrated Circuit”) type. As an example, processing unit 104 and secure circuit 106 are implemented on two different integrated circuits.

As an example, the processing unit comprises a volatile memory 110 (RAM) as well as a non-volatile memory 112 (NV MEM). Volatile memory 110 is for example a random access volatile memory. Non-volatile memory 112 is for example a FLASH-type memory. Memories 110 and 112 are for example coupled via a bus 114.

Processing unit 104 is for example configured to be paired with secure circuit 106. The pairing between processing unit 104 and secure circuit 106 is performed by means of pairing keys. The pairing of processing unit 104 with secure circuit 106 implies for example the sharing of a secret common between these two circuits allowing secure communications therebetween. As an example, one or a plurality of pairing keys, such as for example one or a plurality of symmetric keys, and/or a pair of private and public keys, are generated, for example by processing unit 104, and are transmitted to secure circuit 106. The pairing key(s) are for example generated by cryptographic processors 116 and 118 (CRYPTO1, CRYPTO2) comprised in a peripheral circuit 119 (PERIPHERAL) of processing unit 104. Cryptographic processors 116 and 118 are for example coupled by a dedicated bus (not illustrated) inside of processing unit 104. Peripheral circuit 119 is for example coupled to memories 110 and 112 via bus 114.

The keys are for example used at each request for a communication between processing unit 104 and secure circuit 106, for example, by means an asymmetric ciphering and deciphering. In another example, the pairing and the communication between processing unit 104 and secure circuit 106 are performed by means of a symmetrical cipher and decipher key.

The pairing key(s) should thus be accessible all along the lifetime of device loft Secure circuit 106 for example comprises protection mechanisms making difficult an attack targeting the pairing key(s) and/or other data stored inside of this circuit. However, the storage of the pairing key(s) in non-volatile memory 112 is space-consuming and risky in terms of security. Indeed, an attacker of processing unit 104 might obtain information relative to the key(s), which would jeopardize the security not only of processing unit 104, but also of secure circuit 106, and more generally of device 100.

In the described embodiments, processing unit 104, and more particularly cryptographic processors 116 and 118, are configured to generate the pairing keys at each request for communication with secure circuit 106 or at each session of use of device 100. Thus, in the described embodiments, the pairing key(s) are neither stored in memories no and/or 112 not in any internal memory of processing unit 104, when no communication between unit 104 and security circuit 106 is going on. Processing unit 104 is then configured to generate the pairing key(s) for a first time, to achieve the pairing with secure circuit 106, and then suppress the generated key(s), until their new generation at the time of a new communication with secure circuit 106.

As an example, secure circuit 106 comprises a memory 120 (OTP MEM), memory 120 being for example a one-time programmable memory. Memory 120 is for example configured to store the pairing key(s) transmitted by processing unit 104, after their first generation.

Although FIG. 1 illustrates a pairing between a processing unit and a secure circuit, in other embodiments, the pairing may be performed between any two devices, secure or not.

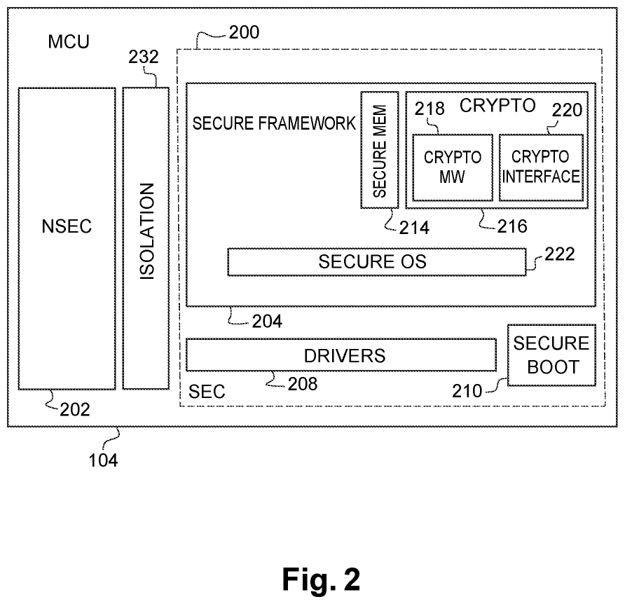

FIG. 2 very schematically shows in the form of blocks processing unit 104 configured for the generation of the pairing key(s). FIG. 2 illustrates, in particular, software functions implemented by processing unit 104. Software configured to implement these functions is for example stored in non-volatile memory 112 and/or loaded into volatile memory 110.

Processing unit 104 for example comprises a secure area 200 (SEC) and a non-secure area 202 (NSEC).

Area 200 for example comprises an area 204 (SECURE FRAMEWORK) comprising intermediate trusted firmware to ensure links with certain circuits of electronic device 100.

Area 200 further comprises driver software 208 (DRIVERS) as well as a boot code 210 (SECURE BOOT).

Area 204 for example comprises one or a plurality of software programs configured to manage trusted and/or secure memory areas of processing unit 104. For example, area 204 comprises a software 214 (SECURED MEM) configured to manage secure memory areas.

Area 204 further comprises a cryptographic module 216 (CRYPTO) configured to ensure a link with the cryptographic processors 116 and 118 of processing circuit 104 and with secure circuit 106. Cryptographic module 216 for example comprises software 218 (CRYPTO MW) configured to drive cryptographic processors 116 and 118, and an interface 220 (CRYPTO INTERFACE) configured to ensure communications with secure circuit 106. Interface 220 is configured to, for example, receive information, such as for example identifiers, transmitted by secure circuit 106. Interface 220 is further for example configured to transmit, to secure circuit 106, the key(s) generated by cryptographic circuits 116 and 118.

Area 204 further comprises a software module 222 (SECURE OS) ensuring the sequencing of units 214 and 216.

Processing unit 104 further comprises an insulation interface 232 separating non-secure area 202 from secure area 200.

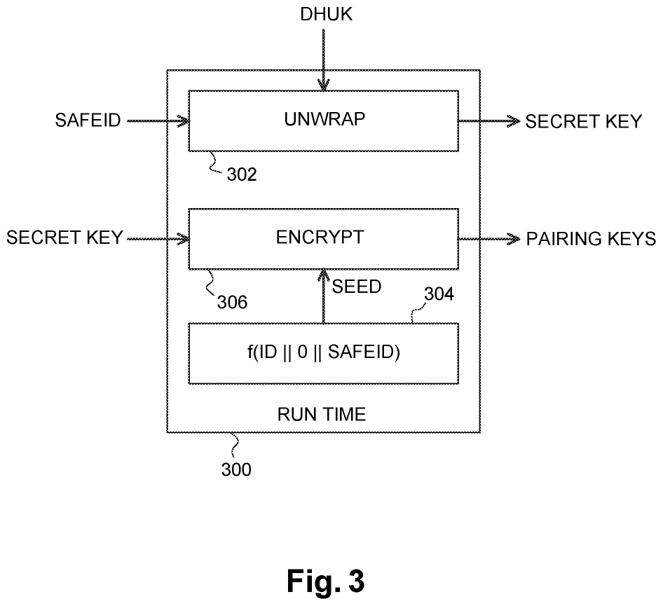

FIG. 3 illustrates a method 300 of generation of one or a plurality of pairing keys by processing unit 104 according to an embodiment of the present disclosure.

The method of FIG. 3 is further carried out each time a pairing is to be implemented between processing unit 104 and secure circuit 106. As an example, the generation of one or a plurality of pairing keys is performed as a response to a request for communication between processing unit 104 and secure circuit 106 during the operation (RUN TIME) of processing unit 104.

To generate the pairing key(s), a hardware key DHUK is for example supplied to cryptographic processor 116. Key DHUK is a unique value specific to the hardware forming processing unit 104 in the context of secure area 200. In particular, in a batch of several hundreds, or even thousands, of processing units 104, each processing unit is for example associated with a corresponding key DHUK, which is unique thereto with respect to the keys DHUK associated with the other processing units 104 in the batch. In certain cases, key DHUK is a key derived from another hardware key ROOT HUK, for example stored in a secure memory area, for example managed by software 214. Key ROOT HUK is for example unique and specific to device 100, whereby derived key DHUK is also unique and specific to device 100. In certain cases, key DHUK and/or key ROOT HUL, are generated according to one or a plurality of unique characteristics of the hardware of processing unit 104. For example, key DHUK and/or key ROOT HUK are generated by a physically unclonable function (“PUF”).

Cryptographic processor 116 is further configured to receive an identifier SAFEID, transmitted by secure circuit 106, for example via bus 108.

As an example, cryptographic processor 116 performs an unwrap operation 302 (UNWRAP), for example corresponding to an operation of decoding of identifier SAFEID using key DHUK, to generate a secret key SECRET KEY. Identifier SAFEID is thus processed by cryptographic processor 116 as if it was data ciphered by key DHUK, although this is not the case. Indeed, the generated key SECRET KEY does not correspond to any decoding of identifier SAFEID, identifier SAFEID being simply not ciphered data. Other operations of generation of key SECRET KEY may of course be envisaged, such as for example the coding of identifier SAFEID by using key DHUK. Key SECRET KEY being obtained from the derived key DHUK, it is unique and specific to device 100.

As an example, processing unit 104 additionally generates a data value SEED from identifier SAFEID, an identifier ID of processing unit 104, and an index value (0). As an example, identifier ID is stored in the non-volatile memory 112 of processing unit 104. As an example, data value SEED is generated by application of a hash function 304 (f(IDI∥0∥SAFEID)) on identifiers SAFEID and ID and on the index value.

The index value for example enables to generate a plurality of different keys based on a same secret key and on same identifiers SAFEID and ID. This is for example useful to add additional entropy to the final result of the operation by integrating a third party source to the pairing, such as a serial number, a production number, an identifier of a production center, etc. In another example, the generation of a plurality of different keys based on a same secret key enables to pair processing unit 104 with a plurality of secure circuits. Still in another example, the generation of a plurality of different keys based on a same secret key enables to address the final result towards a plurality of communication channels.

As an example, data value SEED is generated in parallel with the generation of key SECRET KEY, by a calculation circuit (not illustrated) of processing unit 104. In another example, data value SEED is generated by cryptographic processor 118, in parallel with the generation of key SECRET KEY by cryptographic processor 116. Still in another example, data value SEED is generated by cryptographic processor 116 before, in parallel with or after, the generation of key SECRET KEY.

Key SECRET KEY is then for example transmitted, with data value SEED, to cryptographic processor 118. In certain cases, after the generation of key SECRET KEY during operation 302, the latter is directly used in operation 306, without being stored in any memory of processing unit 104.

Cryptographic processor 118 then generates one or a plurality of pairing keys PAIRING KEYS, for example, by application of a cipher operation 306 (ENCRYPT) on key SECRET KEY and on data value SEED. As an example, the used cipher algorithm is of AES type, although the use of other cipher algorithms is possible, such as DES-type algorithms, an elliptic curve cipher algorithm, etc. It is of course possible to generate the pairing key(s) by applying a key derivation operation implying no cipher operation.

As an example, at the first generation of pairing key(s) PAIRING KEYS, the latter are transmitted, by processing unit 104, to secure circuit 106 via bus 108. The keys are then for example definitively stored in memory 120. However, after this generation, processing unit 104 suppresses the generated keys. Thus, secure circuit 106 is then definitively paired with processing unit 104, but processing unit 104 forgets this pairing.

As an example, on transmission of the pairing keys to secure circuit 106, after their first generation, processing unit 104 programs a configuration value indicating that the pairing keys have already been transmitted to secure circuit 106, so that the pairing keys are not transmitted again to secure circuit 106 at a next generation of these keys. In another example, processing unit 104 interrogates secure circuit 106 to determine whether the pairing keys are for example already stored in memory 120.

As an example, the first generation of pairing keys is performed as a response to a request for pairing between processing unit 104 and secure circuit 106. The pairing request is for example performed on manufacturing of device 100 and in a secure environment.

As an example, a new request for communication with secure circuit 106 is for example initiated by software executed by processing unit 104. Processing unit 104 then generates again the pairing key(s) to be able to perform the communication. The pairing key(s) are then directly used by processing unit 104. For this purpose, key(s) PAIRING KEYS are for example temporarily stored in memory no and are suppressed after their use. The pairing key(s) are then for example not transmitted again to secure circuit 106 since they are already stored in the memory 120 of secure circuit 106.

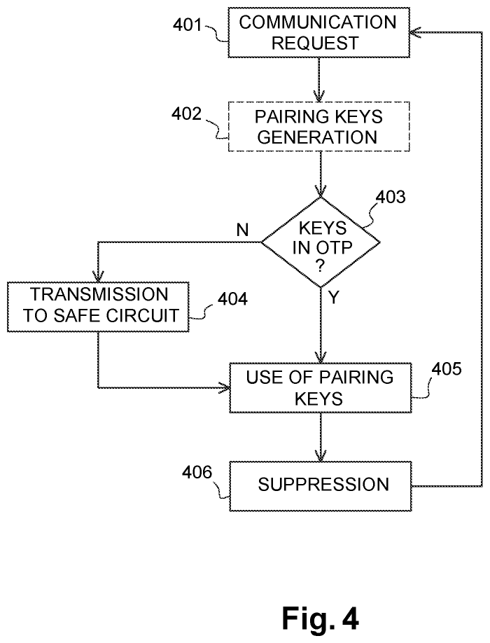

FIG. 4 is a flowchart of a method of generation of pairing keys according to an embodiment of the present disclosure.

At a step 401 (COMMUNICATION REQUEST), a request for communication or pairing between processing unit 104 and secure circuit 106 is initiated in processing unit 104. As an example, the secure circuit is configured to perform one or a plurality of cryptographic functions and a communication request occurs when processing unit 104 has data to transmit to secure circuit 106 for coding or decoding. The secure circuit 106 is further configured to furnish the identifier SAFEID to the processing unit 104. For example, the identifier SAFEID is furnished to the cryptographic processor 116 of the processing unit 104.

At a step 402 (PAIRING KEYS GENERATION), the pairing key(s) between secure circuit 106 and processing unit 104 are generated. The generation is performed by processing unit 104, and for example according to the method described in relation with FIG. 3. It is of course possible to generate the pairing key(s) according to a method different from that described in relation with FIG. 3. The key(s) are further for example temporarily stored in one of memories 110, 112.

At a step 403 (KEYS IN OTP?), it is determined whether the pairing keys are already stored in memory 120. This is for example the case when step 401 is subsequent to a pairing request.

As an example, the determination of step 403 is performed by verification of the state of a configuration value, for example stored in non-volatile memory 112. The configuration value is for example programmed by processing unit 104 during the transmission of the pairing key(s) to secure circuit 106.

If it is determined that the pairing keys have not been stored yet into the memory 120 of secure circuit 106 (branch N), the method continues at a step 404 (TRANSMISSION TO SAFE CIRCUIT). The key(s) generated at step 402 are then transmitted, for example via the interface 220 of cryptographic circuit 216 and via bus 108, to secure circuit 106. Secure circuit 106 then stores the key(s) in memory 120. Memory 120 being for example of one-time programmable type, the storage of the pairing key(s) is then definitive.

After step 404, or if it is determined at step 403 that the pairing key(s) have already been stored in memory 120 (branch Y), the method carries on at a step 405 (USE OF PAIRING KEYS). The pairing key(s) are then used, for example, to achieve the pairing of processing unit 104 and of secure circuit 106, or to perform the requested communication at step 401.

After step 405, the pairing key(s) are suppressed from processing unit 104 at a step 406 (SUPPRESSION). Step 405 further comprises the suppression of value SEED if the latter has been stored within processing unit 104. The step 405, for example, further comprises the suppression, inside the processing unit 104, of the value of the identifier SAFEID. Following step 405, the processing unit 104 is then for example unable to generate the pairing key(s) without receiving, from the secure circuit 106, of the value of the identifier SAFEID. The method then resumes at step 401, when a new request for communication between processing unit 104 and secure circuit 106 is initiated.

An advantage of the described embodiments is that, by regenerating the pairing keys by means of the processing unit at each request, there is no need to store them in the processing unit when no communication operation between the unit and the secure circuit is going on.

Another advantage of the described embodiments is that the use of a single hardware key prevents, once the secure circuit has been paired with the processing unit, the secure communication between the secure circuit and another element, for example belonging to another device.

Various embodiments and variants have been described. Those skilled in the art will understand that certain features of these various embodiments and variants may be combined, and other variants will occur to those skilled in the art. In particular, the selection of the type of the cryptographic operations implemented for the generation of the pairing key(s) by cryptographic circuits 116 and 118 is within the abilities of those skilled in the art.

Finally, the practical implementation of the described embodiments and variants is within the abilities of those skilled in the art based on the functional indications given hereabove, in particular, as for the software implementation of processing unit 104.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
receiving, by a first circuit of a device, a first identifier from a second circuit;
generating, by the first circuit, at least one key based on the first identifier, a second identifier of the first circuit and a first key;
storing, by the first circuit, the at least one key in a memory of the device;
transmitting, by the first circuit, the at least one key to the second circuit; and
removing, by the first circuit, the at least one key from the memory,
wherein the at least one key is generated by the first circuit in response to a request for communication with the second circuit, and
wherein the first circuit executes one or more cryptographic operations based on the at least one key.

2. The method according to claim 1,
wherein the first identifier is stored in the memory of the device,
wherein, after transmitting the at least one key to the second circuit, the method further comprises:
suppressing the first identifier from the memory of the device, and
newly generating the at least one key after newly receiving, by the first circuit, the first identifier sent by the second circuit.

3. The method according to claim 1,
wherein the first identifier is stored in the memory of the device,
wherein, after transmitting the at least one key to the second circuit, the method further comprises:
suppressing the first identifier from the memory of the device, and
again receiving, by the first circuit, the first identifier sent from the second circuit; and
again generating, by the first circuit, the at least one key following again receiving the first identifier.

4. The method according to claim 1, wherein generating the at least one key comprises:
generating, by the first circuit, a second key based on the first key and the first identifier; and
generating, by the first circuit, the at least one key based on the second key and a first data value.

5. The method according to claim 4, wherein generating the second key is performed by a first cryptographic processor of the first circuit, and wherein generating the at least one key is performed by a second cryptographic processor of the first circuit.

6. The method according to claim 5, wherein a value of the second key is transmitted by the first cryptographic processor to the second cryptographic processor via a dedicated bus coupling together the first and second cryptographic processors.

7. The method according to claim 4, wherein the first data value is generated by the first circuit based on the first identifier, the second identifier and an index value.

8. The method according to claim 7, wherein the first data value is generated by applying a hash algorithm on the first identifier, the second identifier and the index value.

9. The method according to claim 1, wherein the first key is a key depending on a hardware of the first circuit.

10. The method according to claim 1, wherein the first key is a key derived from a third key, the third key depending on a hardware of the first circuit.

11. The method according to claim 1, wherein the at least one key comprises a pair of asymmetric keys.

12. An electronic device comprising:
a first circuit configured to:
receive a first identifier from a second circuit;
generate at least one key based on the first identifier, a second identifier of the first circuit and a first key;
store the at least one key in a memory of the device;
transmit the at least one key to the second circuit;
remove the at least one key from the memory;
wherein the at least one key is generated as a response to a request for communication with the second circuit; and
execute one or more cryptographic operations based on the at least one key.

13. The device according to claim 12, further comprising:
a first cryptographic processor configured to generate a second key based on the first key and the first identifier; and
a second cryptographic processor configured to generate the at least one key based on the second key and a first data value,
wherein the first and the second cryptographic processors are coupled by a dedicated bus.

14. The device according to claim 13, wherein the first cryptographic processor is configured to directly transmit a value of the second key to the second cryptographic processor.

15. The device according to claim 13, wherein the first circuit is configured to generate the first data value based on the first identifier, the second identifier and an index value.

16. The device according to claim 15, wherein the first circuit is configured to generate the first data value by applying a hash algorithm on the first identifier, the second identifier and the index value.

17. The device according to claim 12, wherein the first key is a key depending on a hardware of the first circuit.

18. The device according to claim 12, wherein the first key is a key derived from a third key, the third key depending on a hardware of the first circuit.

19. The device according to claim 12, wherein the second circuit is part of the device.

20. The device according to claim 19, wherein the second circuit comprises a one-time programmable memory configured to store the at least one key generated by the first circuit.
